(19) United States
(12) Patent Application Publication
(10) Pub. No.: US 2006/0218393 A1
(43) Pub. Date: Sep. 28, 2006

(54) Systems and methods for adaptive authentication

(76) Inventors: Hendrich M. Hernandez, Round Rock, TX (US); Robert L. Winter, Georgetown, TX (US)

Correspondence Address: William W. Enders;O'KEEFE, EGAN & PETERMAN, Building C, Suite 200, 1101 Capital of Texas Highway South, Austin, TX, 78746, US

(21) Appl. No.: 11/088,214

(22) Filed: Mar. 23, 2005

(51) Int. Cl. H04L 9/00

(52) U.S. Cl. 713/167

(57) ABSTRACT

Systems and methods for authentication of a client device within a network using one or more characteristics of the authentication method/s previously used to authenticate the client device for network communications.

### BACKGROUND OF THE INVENTION

1. Field of the Invention

This invention relates generally to networks, and more particularly to device authentication in networking environments.

2 Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In a typical wireless network, wireless information handling system devices must be authenticated before access to network services is granted. To accomplish this task, an information handling system configured in the form of an authentication server or other type of network authentication device may be set up to support a large number of wireless authentication methods in the form of security modes and algorithms. A given wireless information handling system communicating as a client with the network authentication device is typically set up to use one of these wireless authentication methods. When authenticating the wireless client, the authentication device must take the time to cycle through all of the wireless authentication methods until it finds the correct wireless authentication method supported by the client.

In one conventional network authentication scheme, edge authentication for wireless client devices may be performed by a wireless access point (wireless switch or wireless access point) that supports a number of different authentication methods and chooses the proper authentication method for a given client prior to granting access to the core network where further authentication may occur. EAP is a standard mechanism for granting network access and is defined in Internet Engineering Task Force (IETF) Request for Comments (RFC) 3746. EAP defines a procedure for requesting and granting network access using an authentication authority, usually a Remote Authentication Dial-In User Service (RADIUS) server. EAP is the mechanism for authentication, but the authentication specifics are carried within EAP frames. EAP frames, in turn, are carried within IEEE 802.IX frames in a layer 2 wired or wireless (802.11) network. FIG. 1 illustrates conventional 802.1X and EAP identity convergence scheme as it is practiced in the prior art between a given client device and a wireless gateway access point following association of the client device with the access point. As described further below, convergence to a desired authentication method may take multiple attempts, with each attempt represented by an EAP request/response pair.

In FIG. 1, the access device must “guess” the EAP authentication method used by the given wireless client device by repeatedly transmitting EAP Identity Requests, with each request containing a different type of EAP authentication method (TYPE). The wireless client responds to each EAP Identity Request with an EAP Identity Response that contains a negative acknowledgement (NAK) when the received EAP Identity Request does not contain the correct type of EAP authentication method for the given wireless client device. This process continues as many times as necessary until EAP convergence occurs (i.e., agreement between the client device and the gateway device on a particular EAP authentication method), and the wireless client responds to a particular EAP Identity Request with an EAP Identity Response that contains a positive acknowledgement (TYPE) of the correct EAP authentication method used by the client. Because the EAP protocol supports up to 256 authentication methods (with more than 50 authentication methods currently known to be used with EAP) it can take a significant amount of time for EAP convergence to occur. Due to this trial and error methodology, wireless authentication convergence using traditional 802.IX and EAP (Extensible Authentication Protocol) based methods may consume a relatively large amount of time at the same time that many wireless services (voice, video) require low-latency authentication.

### SUMMARY OF THE INVENTION

Disclosed herein are systems and methods for authentication of information handling systems as client devices within a network. Using the disclosed systems and methods, one or more characteristics of the authentication method/s (e.g., authentication mode/s and algorithm/s) previously used by a given client device (e.g., wireless client device) may be stored (e.g., in cache memory) by a network authentication device (e.g., authentication server, wireless gateway access point, etc.) for use by the authentication device in the selection of the authentication method for communicating with the given client device. Such authentication method characteristics include, but are not limited to, identity of the last authentication method used by the given client, relative frequency of use of two or more different authentication methods by a given client, pattern of use of two or more different authentication methods by a given client, combinations thereof, etc. Advantageously, the disclosed systems and methods may be implemented in one embodiment to reduce the time needed to achieve authentication convergence over the convergence time required by conventional methods.

In one exemplary embodiment, a cache mechanism may be implemented on a wireless authentication device to store the most recent wireless authentication method (e.g., authentication mode and algorithm) used by the wireless authentication device to authenticate a given wireless client device. The next time the given wireless client device attempts to authenticate with the wireless authentication device, the wireless authentication device may default to the stored wireless authentication method in an attempt to shorten the authentication time by more quickly identifying the correct authentication method being currently employed by the given wireless client device. For example, a wireless device may cache, or save, the last authentication method chosen by an EAP exchange and use that EAP method for the first attempt at a future authentication method selection event. In one embodiment, the disclosed systems and methods may be implemented for use in wireless networks that are homogeneous with regard to authentication methods in order to cache an EAP method and streamline EAP method convergence between a wireless device and authentication wireless authentication device (e.g., access point) in a manner that conforms to standards.

In a further exemplary embodiment, a wireless authentication device may additionally or alternatively track (e.g., using a counter/s) the frequency or number of times that a given wireless client uses a given wireless authentication method (e.g., authentication mode and algorithm) relative to other wireless authentication method/s. In such an implementation the wireless authentication device may use the tracked relative frequency of use of a given wireless authentication method to prioritize two or more different authentication methods. For example, if the most recent most recent wireless authentication method is not a correct match for the current authentication method employed by a wireless client device, then the wireless authentication device may then try the remaining possible wireless authentication methods in the order of tracked relative frequency of use until the correct current wireless authentication method is found. Alternatively, a wireless authentication device may start by trying the possible wireless authentication methods in the order of tracked relative frequency of use, rather than by starting with the wireless authentication method last used by the given wireless client.

In one respect, disclosed herein is a method of communicating with an information handling system, the method including: selecting a network authentication method; and communicating the identity of the selected network authentication method to the information handling system, in which the authentication method is selected based on one or more characteristics of at least one authentication method previously used to authenticate the information handling system for network communications.

In another respect, disclosed herein is a method of communicating with a first information handling system configured as a client device, the method including: storing in a memory of a second information handling system configured as a network authentication device one or more characteristics of at least one authentication method previously used by the network authentication device to authenticate the client device for wired or wireless network communications; receiving an authentication request in the network authentication device by wired or wireless communication from the client device; selecting a first network authentication method based on the one or more characteristics of the at least one authentication method previously used by the network authentication device to authenticate the client device for wired or wireless network communications that are stored in the memory of the network authentication device; and communicating the identity of the first selected network authentication method by wired or wireless communication to the client device.

In another respect, disclosed herein is an information handling system, the information handling system being configured to: select a network authentication method based on one or more characteristics of at least one authentication method previously used to authenticate a client information handling system for network communications; and communicate the identity of the selected network authentication method to the client information handling system.

### BRIEF DESCRIPTION OF THE DRAWINGS

FIG. 1 illustrates a conventional identity convergence scheme between a wireless client device and a wireless gateway access point.

FIG. 2 is simplified diagram of a networking environment according to one exemplary embodiment of the disclosed systems and methods.

FIG. 3 is simplified diagram of a networking environment according to one exemplary embodiment of the disclosed systems and methods.

FIG. 4 is a simplified block diagram illustrating communication between an authentication device and client device according to one exemplary embodiment of the disclosed systems and methods.

FIG. 5 is a flowchart illustrating authentication methodology according to one exemplary embodiment of the disclosed systems and methods.

FIG. 6 illustrates an identity convergence scheme between a wireless client device and a wireless gateway access point according to one exemplary embodiment of the disclosed systems and methods.

### DESCRIPTION OF ILLUSTRATIVE EMBODIMENTS

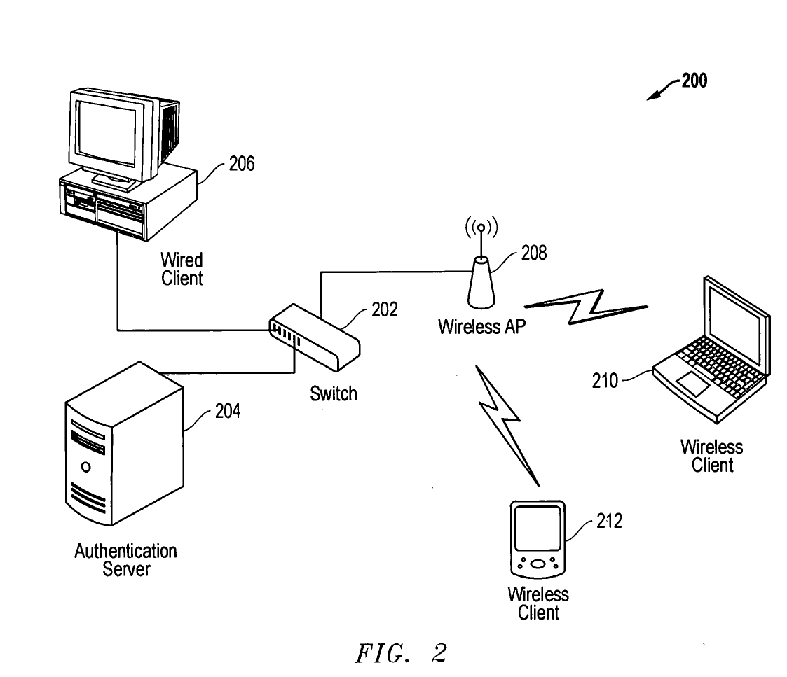

FIG. 2 is a simplified diagram of a networking environment 200 according to one exemplary embodiment in which the disclosed systems and methods may be implemented to authenticate both wired and wireless network devices. As shown, networking environment 200 includes a number of exemplary wireless and wired devices that may be configured to communicate with each other via wireless or wired communications, respectively. Although both wireless and wired devices are illustrated, it will be understood that the disclosed systems and methods may be implemented to authenticate devices for networking communications in any other type of networking environment, e.g., in networking environments that include only wireless devices, or in networking environments that include only wired devices. Furthermore, the disclosed systems and methods may be implemented to authenticate network communications in a variety of networking environment types, e.g., home networking environments, office networking environments, etc.).

In the exemplary embodiment of FIG. 2, networking environment 200 includes wireless client devices 210 and 212 that are illustrated as portable information handling systems in the form of a notebook computer and personal data assistant (PDA), respectively. Networking environment 200 also includes a wired client device 206 in the form of a desktop computer. As shown, each of wireless client devices 210 and 212 are configured to communicate with other devices of networking environment 200 via wireless access point 208 and network switch 202. Wired client device 206 is shown configured to communicate with other devices of networking environment 200 via switch 202. An authentication device 204 is shown coupled to switch 202 for communication with wired and wireless client devices of networking environment 200. In the illustrated embodiment of FIG. 2, authentication device 204 is shown as an authentication server (e.g., RADIUS server) that is coupled to communicate with other network devices via hardwire connection to network switch 202.

With regard to the exemplary configuration of FIG. 2, it will be understood that the number and types of illustrated wired and wireless client devices are exemplary only, and that the disclosed systems and methods may be practiced with any other number and/or type/s of information handling systems suitably configured for wired and/or wireless communication within a given networking environment. Furthermore, it will be understood that the particular illustrated configuration of network switch 202, wireless access point 208 and authentication server 204 is also exemplary only, and that any other suitable configuration of network communication and authentication device/s may be employed, for example, a single common device that is configured to perform the tasks of wireless access point, network router and authentication device.

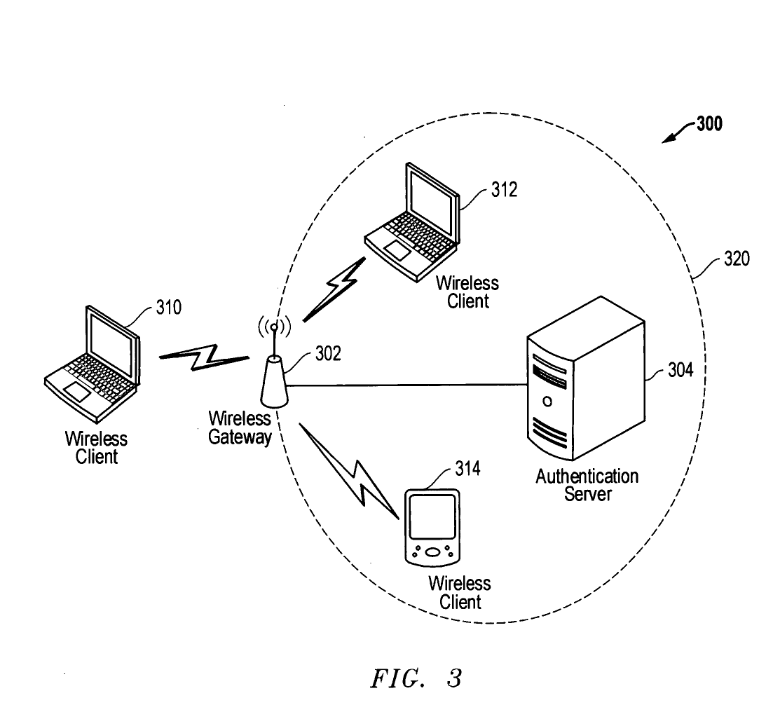

For example, FIG. 3 illustrates a simplified diagram of a networking environment 300 in which the disclosed systems and methods may be implemented in another exemplary embodiment to perform edge authentication for network devices. As shown, networking environment 300 includes a number of exemplary wireless client devices 310, 312 and 314 that may be configured to communicate with each other via wireless communications through an authentication device 302 that is also configured to operate as a wireless gateway access point, e.g., 802.1X access point. As shown, authentication device 302 is coupled via wired connection to an authentication server 304 (e.g., RADIUS server) within the core network 320. Authentication device 302 is configured to receive authentication requests from wireless devices 310, 312 and 314 that do not identify the authentication method in use by the requesting client device, and to perform edge authentication by exchanging information with the requesting client device in order to converge on the correct authentication method prior to allowing the wireless client access to the core network 320. In the illustrated embodiment, authentication server 304 is configured to perform core network authentication tasks (e.g., user validation, etc.) after a given client device 310 is edge-authenticated and allowed access to the core network 320 by authentication device 302. Also shown communicating within core network 320 are wireless client devices 312 and 314 which have been previously granted access to core network 320.

Although both wireless and wired devices are illustrated as being present in the networking environments of FIGS. 2 and 3, it will be understood that the disclosed systems and methods may be implemented to authenticate devices for networking communications in any other types of networking environment, e.g., in networking environments that include only wireless devices, or in networking environments that include only wired devices. Furthermore, the disclosed systems and methods may be implemented to authenticate network communications in a variety of networking environment types, e.g., home networking environments, office networking environments, etc.).

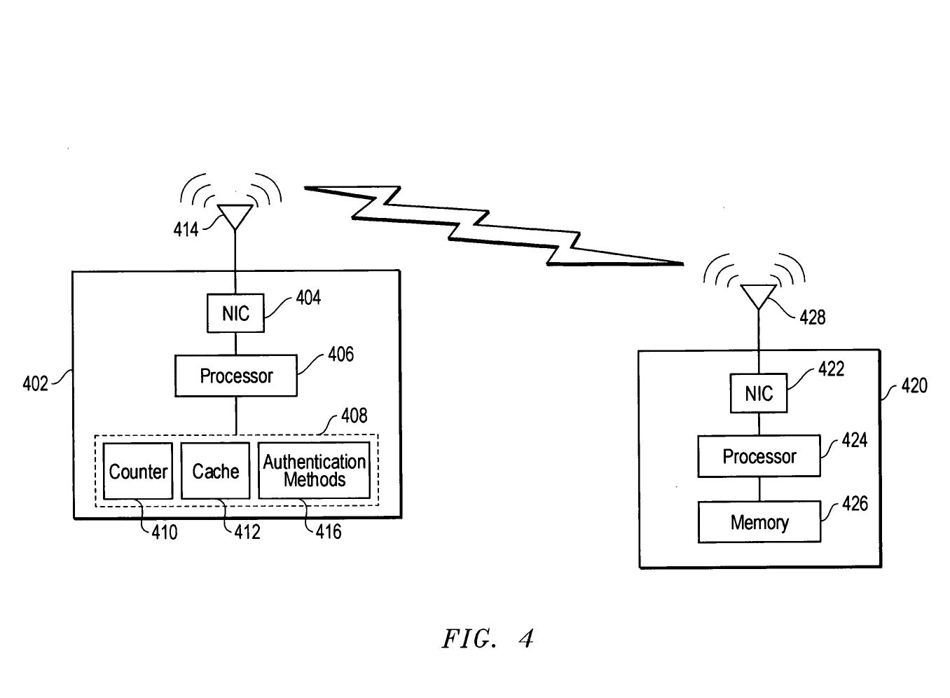

FIG. 4 is a simplified block diagram illustrating communication between an authentication device 402 and client device 420 according to one exemplary embodiment of the disclosed systems and methods. Although devices 402 and 420 are illustrated as communicating wirelessly in FIG. 4, it will be understood that communication between authentication device 402 and 420 may alternatively be via wired connection. In this regard, the authentication capabilities of wireless authentication device 402 may be taken to represent the capabilities of authentication server 204 of FIG. 2 or wireless gateway access point 302 of FIG. 3.

In the illustrated embodiment of FIG. 4, wireless authentication device 402 is shown configured with a processor 406 that is coupled to memory 408 and that is configured to receive and produce network communications via a coupled wireless network interface card (NIC) 404 and antenna 414. Likewise, wireless client device 420 is shown configured with a processor 424 that is coupled to memory 426 and that is configured to receive and produce network communications via a coupled wireless network interface card (NIC) 422 and antenna 428. Memory 408 and 426 may be any suitable memory devices (e.g., solid state memory, hard disk, etc.) or combination of memory devices suitable for storing information necessary or desirable for accomplishing the features of the disclosed systems and methods as described further herein. Similarly, processors 424 may be any processing device/s (e.g., microprocessor, microcontroller, etc.) suitable for retrieving and storing information to attached memory devices, and for executing algorithms or routines necessary or desirable for accomplishing the features of the disclosed systems and methods as described further herein. NICs 404 and 428 may be any network interface card or network adapter components suitable for enabling wireless network communication between wireless authentication device 402 and wireless client device 420 via antennas 414 and 428, it being understood that a wired network embodiment may be implemented by using NIC components suitable for wired network communication between a wired authentication device and a wired client device.

In this embodiment, processor 424 and memory 426 of wireless client device 420 are configured to execute at least one wireless authentication method (e.g., security mode and/or algorithm) in order to produce authentication information that is communicated to authentication device 402 via NIC 428. Wireless authentication device 402 is configured to process the authentication information received from wireless communication device 420 through antenna 414 and NIC 404 using two or more different wireless authentication methods (e.g., security modes and/or algorithms) executing on processor 406.

Still referring to FIG. 4, wireless authentication device 402 may be capable of supporting a plurality of wireless authentication methods 416, for example, corresponding to different types and/or brands of client devices, different network policies (e.g., security level or work group policies) for different wireless client devices and/or users, etc. These multiple wireless security methods 416 may be stored in memory 408 of wireless authentication device 402, and chosen and used as necessary to authenticate different wireless client devices and/or users on a dynamic as-needed basis. Table 1 is an exemplary listing of wireless authentication methods 416 that may be stored in memory 408 of wireless authentication device 402 and is not intended to comprehensive, it being understood that the number of stored wireless authentication methods 416 may be greater or lesser, and/or that different types of wireless authentication methods may also be stored in memory 408.

TABLE 1
Authentication Methods

| | Network | | Data | Network | |
|---|---|---|---|---|---|
| Security | Authentication | | Encryption | Authentication | Cache |
| Type | Algorithm | Tunneling Protocol | Method | Mode | Entry ID |
| None | Open | N/A | Wired Equivalent | N/A | 1 |
| | | | Privacy (WEP) | | |
| | | | None | | 2 |
| Basic | Shared | N/A | WEP | N/A | 3 |
| | | | None | | 4 |
| | Wi-Fi Protected | N/A | WEP | N/A | 5 |
| | Access Pre-Shared | | Temporal Key | | 6 |
| | Key (WPA-PSK) | | Integrity Protocol | | |
| | | | (TKIP) | | |
| | | | Advanced | | 7 |
| | | | Encryption | | |
| | | | Standard (AES) | | |
| Advanced | Message Digest | N/A | WEP | 802.1x | 8 |
| | Algorithm 5 (MD5) | | Cisco Key Integrity | | 9 |
| | | | Protocol (CKIP) | | |
| | Lightweight | N/A | WEP | 802.1x, Cisco | 10 |
| | Extensible | | | Centralized Key | |
| | Authentication | | | Management (CCKM) | |
| | Protocol (LEAP) | | CKIP | 802.1x, Cisco | 11 |
| | | | | Compatible Extension | |
| | | | | (CCX), CCKM | |
| | | | TKIP | Wi-Fi Protected | 12 |
| | | | | Access (WPA), | |
| | | | | CCKM | |
| | Transport Layer | N/A | WEP | 802.1x | 13 |
| | Security (TLS) | | CKIP | 802.1x | 14 |
| | | | TKIP | WPA | 15 |
| | | | AES | WPA | 16 |
| | Protected Extensible | Generic Token Card (GTC), | WEP | 802.1x | 17 |
| | Authentication | TLS, Microsoft Challenge | CKIP | 802.1x | 18 |
| | Protocol (PEAP) | Handshake Authentication | TKIP | WPA | 19 |
| | | Protocol (MS-CHAP) v2 | AES | WPA | 20 |
| | Tunneled Transport | Password Authentication | WEP | 802.1x | 21 |
| | Layer Security (TTLS) | Protocol (PAP), Challenge | CKIP | 802.1x | 22 |
| | | Handshake Authentication | TKIP | WPA | 23 |
| | | Protocol (CHAP), MD5, | AES | WPA | 24 |
| | | MS-CHAP, MS-CHAP v2 | | | |

As shown in Table 1, each wireless authentication method of this exemplary wireless authentication embodiment may be selected to correspond to a particular combination of authentication characteristics, i.e., wireless WLAN security type (e.g., none, basic or advanced), network authentication algorithm, tunneling protocol, data encryption method and network authentication mode. However, it will be understood that in other embodiments an individual wired or wireless authentication method may correspond to any other authentication characteristic or combination of authentication characteristics as may be suitable for use in implementing one or more features of the disclosed systems and methods in a given wireless networking environment. In one exemplary embodiment, the information contained in Table 1 may be stored as an authentication method look-up table in memory 408 of wireless authentication device 402. In such a case, a cache entry identifier (ID) may be employed to identify each combination of authentication characteristics supported by wireless authentication device 402.

As shown in FIG. 4, memory 408 of wireless authentication device 402 may also include authentication cache 412 for maintaining information concerning the identity of authentication method/s utilized by wireless client device 420 and other wireless client devices 420 (when present), e.g., a listing of all authentication methods previously used by each wireless client device 420, the authentication method last used by each wireless client device 420, a listing of all authentication methods supported by each wireless client device 420, etc. Memory 408 may also include an optional counter 410 for tracking the frequency of use or cumulative usage count for each wireless authentication method (e.g., algorithm and mode) used by each wireless client device 420.

Table 2 shows an exemplary embodiment of authentication method tracking table as it may be maintained by optional counter 410 (when present) of a wireless authentication device 402 for multiple wireless client devices 420. As shown in Table 2, a usage counter (e.g., since last system boot-up) may be maintained for each wireless client device 420 (e.g.,. Client A, Client B, etc.) for each wireless authentication method employed by the given wireless client device 420. In the illustrated embodiment, time stamps may also be kept for the last date and time of use for each authentication method utilized by each wireless client device 420, although this is not necessary. As shown, Table 2 includes a cache entry identifier (ID) that corresponds to the cache entry identifiers of Table 1 to allow identification of each wireless authentication method included in Table 2.

TABLE 2
Authentication Method Tracking

| | Client A | | | Client B | | |
|---|---|---|---|---|---|---|
| Cache | Usage Counter | Last used | Last used | Usage Counter | Last used | Last used |
| Entry ID | Since Last Boot | Date Stamp | Time Stamp | Since Last Boot | Date Stamp | Time Stamp |
| 1 | 1 | 2/14/2003 | 13:15 | 0 | | |
| 2 | 2 | 3/1/2004 | 8:00 | 0 | | |
| 3 | 0 | | | 0 | | |
| 4 | 0 | | | 2 | 6/12/2003 | 16:15 |
| 5 | 0 | | | 3 | 5/12/2003 | 15:30 |

Table 3 shows an authentication method cache information table as it may be maintained in cache memory 412 of wireless authentication device 402 according to one exemplary embodiment of the disclosed systems and methods. As shown, Table 3 includes a respective identifier A to Z (e.g., MAC address or other suitable identifier) corresponding to each of wireless client devices A to Z that have been previously authenticated (or that may attempt authentication) by wireless authentication device 402. In this exemplary embodiment, the authentication mode cache structure of Table 3 includes the cache entry identifier for the last used (LU) authentication method for each wireless client device A to Z, as well as the cache entry identifier for the most used (MU) authentication method for each wireless client device A to Z.

TABLE 3
Authentication Method Cache

| | LU | MU |
|---|---|---|
| Client MAC Address | Cache Entry ID | Cache Entry ID |
| A | 2 | 2 |
| B | 5 | 4 |
| . | . | . |
| . | . | . |
| . | . | . |
| Z | 6 | 2 |

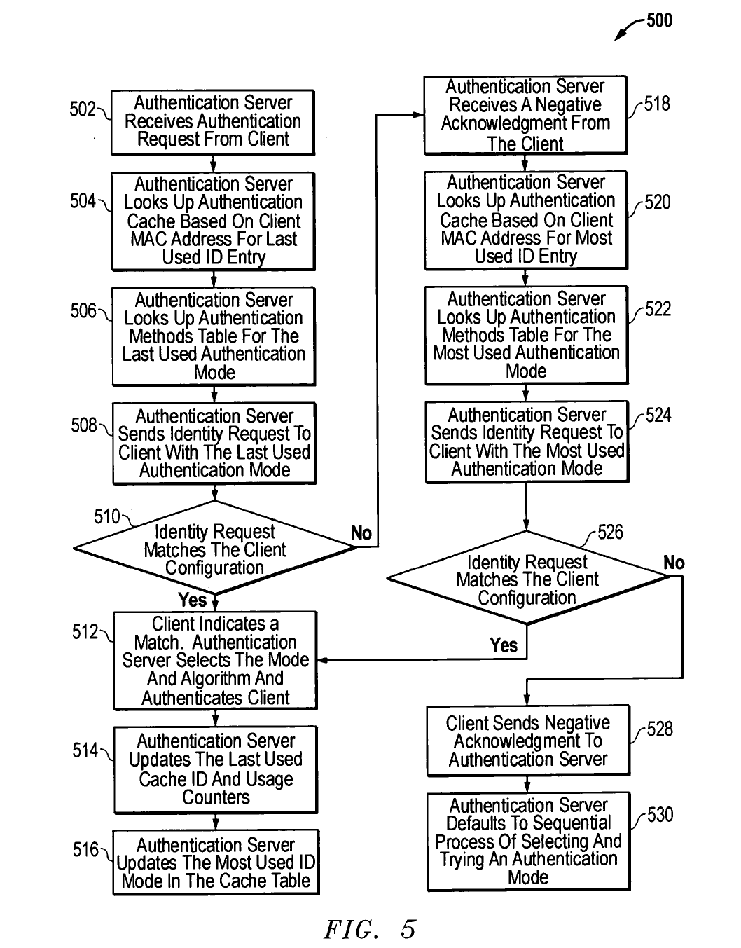

FIG. 5 is a flowchart illustrating authentication methodology 500 as it may be implemented according to one exemplary embodiment of the disclosed systems and methods, e.g., as part of handshake operations between a wireless client device and a wireless authentication device. Methodology 500 may be implemented, for example, by authentication server 204 to authenticate wired client device 206 and/or wireless client devices 210 and 212 of FIG. 2. However, it will be understood that similar methodology may be implemented by other types of authentication devices using wireless and/or wired communication, e.g., by wireless gateway access point 302 of FIG. 3 for edge authentication purposes.

As shown, authentication methodology begins in step 502 where a waiting authentication server receives an authentication request from a given client. The authentication request does not identify the authentication method used by the given client. In response to the authentication request, the authentication server accesses authentication method cache information (e.g., Table 3 contained in authentication cache 412 of FIG. 4) in step 504 and looks up the last used (LU) cache entry identifier (ID) corresponding to the last used authentication method for the MAC address of the given client that has requested authentication. In step 506, the authentication server accesses authentication method information (e.g., Table 1 maintained in authentication method information 416 of FIG. 4) and looks up the last used authentication method corresponding to the LU cache entry identifier obtained in step 504. In step 508, the authentication server sends an identity request to the given client that contains the last used authentication method obtained in step 506.

Still referring to FIG. 5, the requesting client device receives the identity request sent in step 506 from the authentication server and determines in step 510 if the last used authentication method contained in the identity request matches the current client authentication method configuration. If the last used authentication method contained in the identity request matches the current client authentication method configuration, then the client device responds to the authentication server in step 512 with a positive identity response, and the authentication server in turn selects the authentication method (e.g., authentication mode and algorithm) from authentication method memory 416 and authenticates the given requesting client device.

In step 514, the authentication server updates the LU cache entry identifier of the authentication method cache information (e.g., Table 3 contained in cache memory 412 of FIG. 4) with the cache entry identifier corresponding to the identity of the authentication method used in step 512 for the given client. In step 514, the authentication server also updates the cumulative usage counter (that reflects cumulative count of usage) and time stamps contained in the authentication method tracking information (e.g., Table 2 contained in counter 410 of FIG. 4) that correspond to the authentication method used in step 512 for the given client. In step 516, the authentication server updates the MU cache entry identifier of the authentication method cache information (e.g., Table 3 contained in cache memory 412 of FIG. 4) with the cache entry identifier corresponding to the most used authentication method after performance of step 512 for the given client. At this point, methodology 500 terminates and authentication server waits for the next authentication request to be received from a client device in step 502, at which time methodology 500 starts over again to process the next authentication request.

Returning to step 510 of FIG. 5, if the last used authentication method contained in the identity request does not match the current client authentication method configuration, then the client device responds with a negative identity response that is received by the authentication server in step 518. Upon receipt of a negative identity response in step 518, the authentication server authentication server accesses authentication method cache information (e.g., Table 3 contained in authentication cache 412 of FIG. 4) in step 520 and looks up the most used (MU) cache entry identifier (ID) corresponding to the most used authentication method for the MAC address of the given client that has requested authentication. In step 522, the authentication server accesses authentication method information (e.g., Table 1 maintained in authentication method information 416 of FIG. 4) and looks up the most used authentication method corresponding to the MU cache entry identifier obtained in step 520. In step 524, the authentication server sends an identity request to the given client that contains the most used authentication method obtained in step 522.

Still referring to FIG. 5, the requesting client device receives the identity request sent in step 524 from the authentication server and determines in step 526 if the most used authentication method contained in the identity request matches the current client authentication method configuration. If the most used authentication method contained in the identity request matches the current client authentication method configuration, then the client device responds to the authentication server in step 512 with a positive identity response, and completes steps 514 and 516 in a manner as previously described. However, if in step 526 the most used authentication method contained in the identity request sent in step 524 by the authentication server does not match the current client authentication method configuration, then the client device responds with a negative identity response in step 528.

Upon receipt of a negative identity response sent in step 528, the authentication server defaults in step 530 to a sequential process of selecting individual authentication methods and sending identity requests for these selected authentication methods one at a time until the client device responds to the authentication server with a positive identity response (not shown in FIG. 5). Upon receipt of such a positive identity response from the client device, the authentication server in turn selects the authentication method (e.g., authentication mode and algorithm) from authentication method memory 416 and authenticates the given requesting client device. At this time, LU cache entry ID, MU cache entry ID and usage counter and time stamps may be updated in a manner similar to that described in relation to steps 514 and 516. At this point, the authentication server waits for the next authentication request to be received from a client device in step 502, at which time methodology 500 starts over again to process the next authentication request.

It will be understood that methodology 500 of FIG. 5 is exemplary only, and that the disclosed systems and methods may be implemented in other embodiments with additional or fewer steps than included in methodology 500, and/or using an alternative sequence of steps. For example, it is possible to implement an authentication methodology similar to methodology 500 that utilizes any one or more suitable authentication method characteristics to select an authentication method for communicating with a given client device, e.g., only using last used (LU) authentication information, only using most used (MU) authentication information, or that uses most used (MU) authentication information to select a possible authentication method prior to using last used (LU) authentication information. Furthermore, it will be understood that it is not necessary to default to a sequential authentication method selection process as described in relation to step 530, and/or that one or more other authentication method characteristics may be employed in the selection an authentication method for communicating with a given client device, e.g., using next to last used authentication information, selection of next to most used authentication information, etc.

It will also be understood that methodology 500 may be configured to use any suitable authentication method determination method when cache memory (e.g., authentication cache 412 of FIG. 4) contains no previous authentication information for a given authentication-requesting client device (e.g., such as first time a given client requests authentication). For example, if no cache entry identifier (ID) information is found in steps 504 and/or 520 for a given client device, methodology 500 may skip to step 530 for first time selection of the authentication method for the given client device. After an authentication method is used to authenticate a given wireless client for the first time, the LU cache entry ID, MU cache entry ID and usage counter and time stamps may be updated in a manner similar to that described in relation to steps 514 and 516. If necessary, the client device MAC address may be added to memory if not previously present.

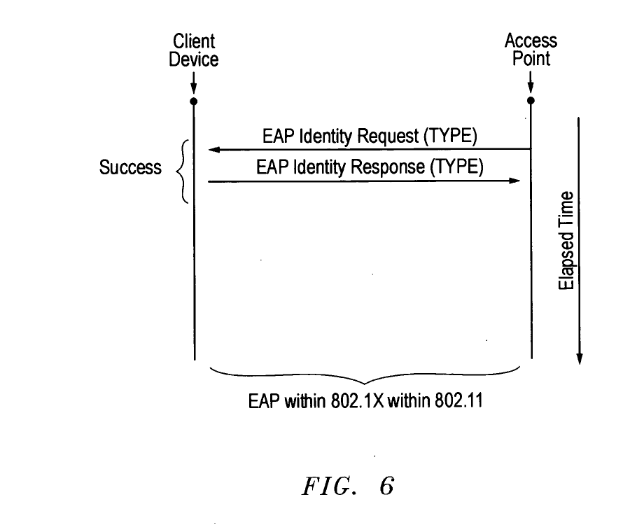

FIG. 6 illustrates an 802.1X and EAP identity convergence scheme according to one exemplary embodiment of the disclosed systems and methods as it may be implemented between a given client device and a wireless gateway access point device following association of the client device with the access point. In this embodiment, the wireless gateway access point has cached previous authentication method information for use in a future EAP exchange. As shown in FIG. 6, the access point device begins by selecting an EAP authentication method based on one or more characteristics of the authentication method/s previously used by the given client device (e.g., using methodology similar to that illustrated and described in relation to FIG. 5) and then transmitting an EAP Identity Request containing the selected EAP authentication method (TYPE). The wireless client responds to this first EAP Identity Request with an EAP Identity Response that contains a positive acknowledgement (TYPE) of the correct EAP authentication method used by the client.

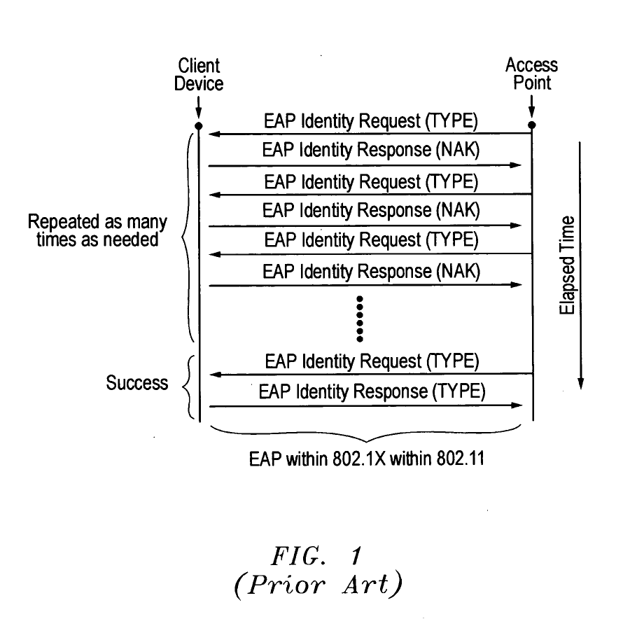

Thus, in the exemplary embodiment of FIG. 6, convergence to the correct authentication method advantageously takes only one attempt, i.e., represented by a single EAP request/response pair. This is in comparison to the multiple attempts (and corresponding multiple EAP request/response pairs) typically required by the conventional methodology of FIG. 1 to achieve convergence to the correct authentication method. Although it will be understood that in some cases it is possible that it will take more than one attempt (i.e., more than a single EAP request/response pair) to achieve convergence to the correct authentication method when using the methodology of the disclosed systems and methods, it will typically require fewer attempts (and less processing time) to achieve convergence with the methodology of the disclosed systems and methods than when using conventional methodology such as illustrated and described in relation to FIG. 1.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. A method of communicating with an information handling system, said method comprising:
selecting a network authentication method;
communicating the identity of said selected network authentication method to said information handling system;
wherein said authentication method is selected based on one or more characteristics of at least one authentication method previously used to authenticate said information handling system for network communications.

2. The method of claim 1, further comprising selecting said network authentication method to be the same as the authentication method last used to authenticate said information handling system for network communications.

3. The method of claim 1, further comprising selecting said network authentication method to be the same as the authentication method most used previously used to authenticate said information handling system for network communications.

4. The method of claim 1, wherein said method further comprises communicating said identity of said selected network authentication method to said information handling system by wireless communication.

5. The method of claim 4, wherein said network authentication method comprises an Extensible Authentication Protocol (EAP).

6. The method of claim 1, wherein said method comprises selecting said network authentication method from two or more network authentication methods previously used to authenticate said information handling system for network communications.

7. The method of claim 1, further comprising authenticating said information handling system for network communications if said selected network authentication method matches the authentication method currently in use by said information handling system.

8. A method of communicating with a first information handling system configured as a client device, said method comprising:
storing in a memory of a second information handling system configured as a network authentication device one or more characteristics of at least one authentication method previously used by said network authentication device to authenticate said client device for wired or wireless network communications;
receiving an authentication request in said network authentication device by wired or wireless communication from said client device;
selecting a first network authentication method based on said one or more characteristics of said at least one authentication method previously used by said network authentication device to authenticate said client device for wired or wireless network communications that are stored in said memory of said network authentication device; and
communicating the identity of said first selected network authentication method by wired or wireless communication to said client device.

9. The method of claim 8, further comprising:
receiving a first response in said network authentication device by wired or wireless communication from said client device, said first response indicating whether said identity of said selected first network authentication method matches the authentication method currently in use by said client device;
authenticating said client device for wired or wireless network communications if said first response indicates that said selected first network authentication method matches the authentication method currently in use by said client device; and
updating said memory of said network authentication device to include one or more characteristics of said selected first network authentication method;
wherein said method comprises selecting said first network authentication method from two or more network authentication methods previously used by said network authentication device to authenticate said client device for wired or wireless network communications; and
wherein said selected first authentication method is the same as the authentication method last used by said network authentication device to authenticate said client device for wired or wireless network communications.

10. The method of claim 8, further comprising:
receiving a first response in said network authentication device by wired or wireless communication from said client device, said first response indicating whether said identity of said selected first network authentication method matches the authentication method currently in use by said client device;
selecting a second network authentication method based on said one or more characteristics of said at least one authentication method previously used by said network authentication device to authenticate said client device for wired or wireless network communications that are stored in said memory of said network authentication device if said first response indicates that said selected first network authentication method does not match the authentication method currently in use by said client device; and
communicating the identity of said second selected network authentication method by wired or wireless communication to said wireless client device.
receiving a second response in said network authentication device by wired or wireless communication from said client device, said second response indicating whether said identity of said selected second network authentication method matches the authentication method currently in use by said client device;
authenticating said client device for wired or wireless network communications if said second response indicates that said selected second network authentication method matches the authentication method currently in use by said client device; and
updating said memory of said network authentication device to include one or more characteristics of said selected second network authentication method;
wherein said method comprises selecting said first and second network authentication methods from two or more network authentication methods previously used by said network authentication device to authenticate said client device for wired or wireless network communications;
wherein said selected first authentication method is the same as the authentication method last used by said network authentication device to authenticate said client device for wired or wireless network communications; and
wherein said selected second authentication method is the same as the authentication method most used previously to authenticate said client device for wired or wireless network communications.

11. The method of claim 8, wherein said client device comprises a wireless client device; and wherein said network authentication device comprises a wireless network authentication device.

12. The method of claim 11, wherein said wireless network authentication device comprises a wireless gateway access point configured to perform edge network authentication.

13. The method of claim 8, wherein said network authentication device comprises an authentication server configured to perform core network authentication.

14. An information handling system, said information handling system being configured to:
select a network authentication method based on one or more characteristics of at least one authentication method previously used to authenticate a client information handling system for network communications; and
communicate the identity of said selected network authentication method to said client information handling system.

15. The information handling system of claim 14, wherein said information handling system is further configured to select said network authentication method from two or more network authentication methods previously used to authenticate said client information handling system for network communications; to communicate said identity of said selected network authentication method to said client information handling system; and to authenticate said client information handling system for network communications if said selected network authentication method matches the authentication method currently in use by said client information handling system.

16. The information handling system of claim 15, wherein said information handling system is further configured to select said network authentication method to be the same as the authentication method last used to authenticate said client information handling system for network communications.

17. The information handling system of claim 15, wherein said information handling system is further configured to select said network authentication method to be the same as the authentication method most used previously to authenticate said client information handling system for network communications.

18. The information handling system of claim 15, wherein said client device comprises a wireless client device; and wherein said network authentication device comprises a wireless network authentication device.

19. The information handling system of claim 18, wherein said information handling system is further configured as a wireless gateway access point configured to perform edge network authentication.

20. The information handling system of claim 15, wherein said information handling system is further configured as an authentication server configured to perform core network authentication.
